(19) United States
(12) Patent Application Publication
(10) Pub. No.: US 2024/0146814 A1
(43) Pub. Date: May 2, 2024

(54) METHOD OF DATA TRANSMISSION AMONG MICRO-SERVICES

(71) Applicant: VIETTEL GROUP, Ha Noi City (VN)

(72) Inventors: Tien Dong Nguyen, Ha Noi City (VN); Duc Binh Tran, Ha Noi City (VN); Phuong Nam Nguyen, Hai Phong City (VN); Anh Tuan Nguyen, Ha Noi City (VN); Quoc Hung To, Ha Noi City (VN)

(73) Assignee: VIETTEL GROUP, Ha Noi City (VN)

(21) Appl. No.: 18/496,957

(22) Filed: Oct. 30, 2023

(30) Foreign Application Priority Data
Oct. 31, 2022 (VN) 1-2022-07076

(51) Int. Cl. H04L 67/141; H04L 67/1004

(52) U.S. Cl. CPC H04L 67/141; H04L 67/1004

(57) ABSTRACT

The method of connection establishment method in data transmission between micro-services in cloud ensures reducing connection complexity between client instances and server instances, increasing the number of connections which helps increase data transmission performance. Besides, the method helps ensure load balancing when server instances change or in time of failure. The proposed method includes the following steps: step 1: data preparation; Step 2: build connection data table; Step 3: select the appropriate connection when receiving a request to send data from the client; step 4: periodically queries the independent service management, updating the current state of the server instances.

### TECHNICAL FIELD

This invention relates to a method for establishing connection used for sending and receiving data between micro-services in cloud environment. It will be applied in the process of establishing HTTP2 connection.

### BACKGROUND

When deploying a virtualized telecommunication network node in cloud, the node will be split into smaller services which follows the “micro-services architecture” and its functional purposes (Network Functions). A subscriber's sessions are distributed and processed in each specific “instance” of those micro-services. Each instance when deploy will have an unique IP address within an internal network address range. If one of the instances is reinitiated (either automatically or manually), the system will assign it a new unique IP address. Normally, the IP address range is /16, thus the number of instances can be large without any confliction of having same IP addresses.

Client instances will not be able to know beforehand all the IP addresses of server side instances because these values are tend to change frequently during operation. Therefore, cloud environment uses the concept of “service” to represent a set of instances of a micro-service which have the same functions. When first deployed, the system will assign a service with an unique IP address (Cluster IP), this IP is only allocated once and will not be changed during the lifetime of the service unless manually changed.

When a client need to communicate with the server, it needs to send messages to the service's IP address. The service will then route these messages to a list of backend instances IP addresses based on the service's initial configurations and the status of the backend instances. The routing is done by load balancing all traffics to the backend IP addresses. However, there are some limitation when using service as a main communication method:
When receiving a request, some instances need to query information on the operating system level, this will affect the performance when the amount of requests increase.
In case the backend instances are changed or are being upgraded, services will need some time in order to update the information, during which the communication is not guaranteed.
For the HTTP2 protocol, after a connection has been established, the following message will be sent on the established connection. In case of increasing the number of server instances, the load balancing feature does not work well, because the connections have been previously established, so messages will not flow to the newly created instance until there are new connections established.

The invention provides a method to establish a connection in sending and receiving data between small services in the cloud environment (specifically with the 5GCore product) to ensure the establishment of a direct connection, between the client instance and the server instance. The method helps reduce complexity, increase performance in communication between instances by bypassing the connection to services, and ensure better load balancing between server instances in time of changes.

### TECHNICAL PURPOSE

The purpose of the proposal is to establish an efficient connection between client and server instances, ensuring the ability to balance traffic to server instances, in accordance with actual system implementation requirements.

To achieve that, the method includes the following steps:

Step 1: preparing data. Initializing client system with a list of server identities to build connections to. Initializing an independent service management within client side that periodically checks the state of all server instances according to the known lists. Initializing a table that stores the connection from the client instance to the servers. Initializing current state table for marking connections as established or in used.

Step 2: building table of connections. Making queries to a target service to ask for the server's backend instances list, this will form a table that stores the connection information between client and server instances.

Step 3: selecting the appropriate connection when receiving a request to send data from the client. At this step, connection selection is made based on the server identity that needs to receive data, the current status of the server's backend instances, and the connection's mark status. After completing the process, update the connection marker table again.

Step 4: update the connection table. At this step, periodically update the current connection data table. Delete inactive connections and add new connections according to the updated list from the independent management service which was initialized in the client side.

### BRIEF DESCRIPTION OF THE DRAWINGS

FIG. 1 depicts the model of communication between the client instance and the server instances.

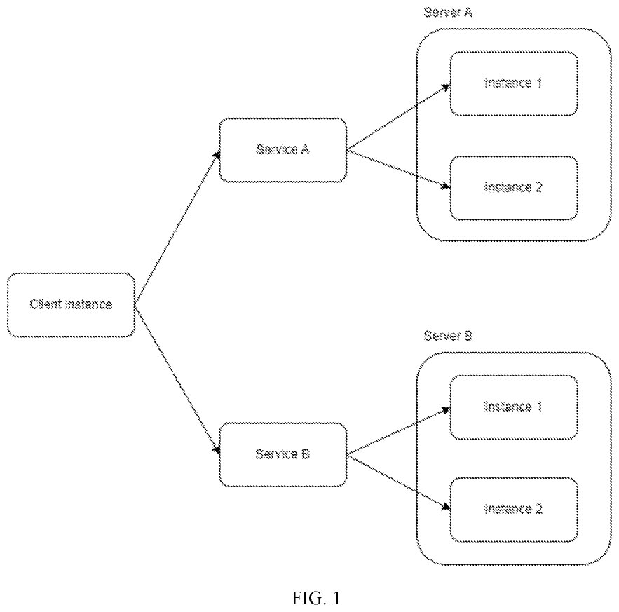

FIG. 2 depicts the model of communication between client instances and server instances according to the method of connection establishment method in data transmission between micro-services in cloud.

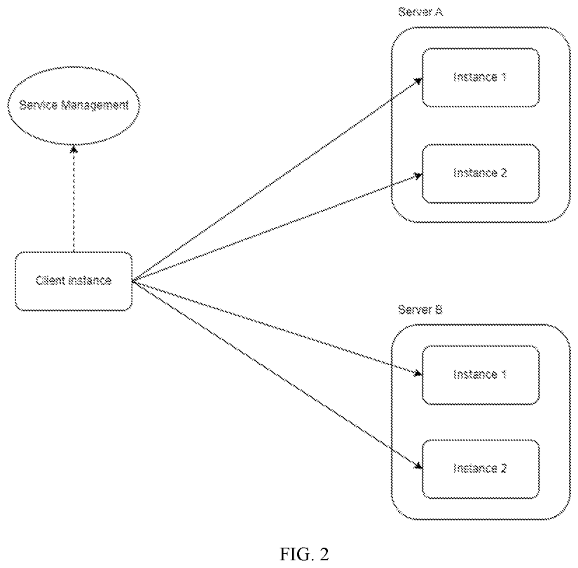

FIG. 3 describes in detail the client's data tables, connections, and data markers.

FIG. 4 depicts the steps taken when a connection is needed in client instance.

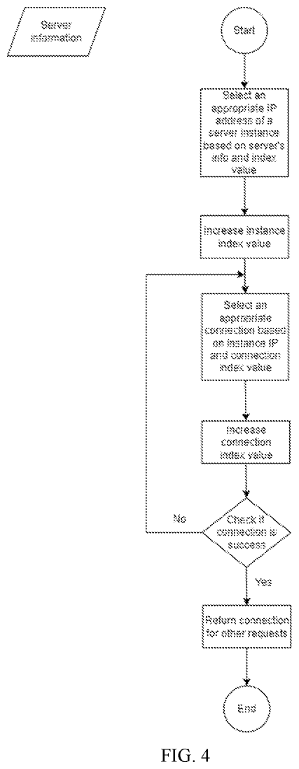

FIG. 5 depicts the steps involved in periodically updating connection data based on the state of the server instances.

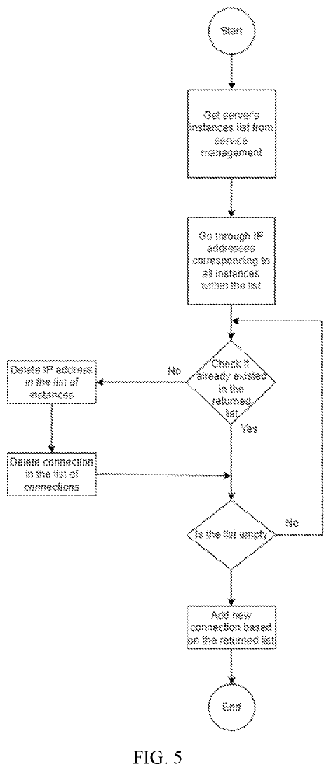

### DETAILED DESCRIPTION

Connection establishment method in data transmission between micro-services in cloud is described as follow:

Step 1: preparing. Client side data will include:

+A list of status and IP information of all backend instances of N servers.

+A list of connections, which includes the connections between the client and M instances of N servers.

+A marking list, which will be used to mark and load balance when selecting IP of server side instances.

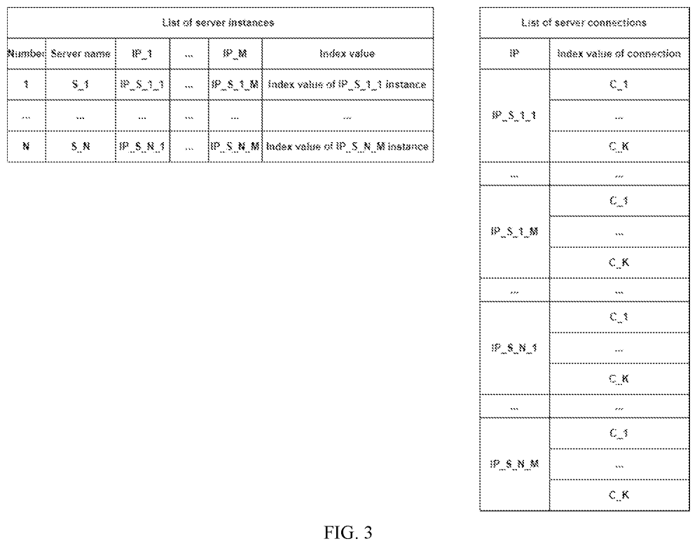

Step 2: building table of connections (FIG. 3).

At this step, make queries to the independent service management to collect information about every instances of the available servers including:
A list of N servers [S_1, . . . , S_N] that need to be connected to.
A list of IP addresses of M instances [IP_1, . . . , IP_M] corresponding to each server [IP_S_1_1, . . . , IP_S_1_M]. Initialize load-balancing indexes value for each instance of each server.

Based on the information within the those lists, create a pool of HTTP2 connections with each IP address of an instance. This pool will includes:
K connections from client to each IP address of each instances of server side [C_1, . . . , C_K].
Index value to mark the connection.

Step 3: selecting an appropriate connection when sending a request from client side.

At this step, based on the request from client and the data stored, select an appropriate connection to send and receive messages over HTTP2 protocol, specifically:

Step 3.1: based on the server identity that will be receiving message from client, select an IP address from the list with index IP_S_X_Y. S_X is the identity of the server, Y is the corresponding index value.

Step 3.2: update the server index value by 1.

Index=(Index+1) % M

Step 3.3: based on the IP address obtained from step 3.1 (IP_S_X_Y), select an appropriate connection based on the index values of connections C_Z. Z is the index value.

Step 3.4: update the connection index value by 1 Index=(Index+1) % K Step 3.5: check the connection. If the connection is not functioning then proceed to reselect a new connection according to step 3.3

Step 3.6: return the used connection for other processes.

Step 4: update the connection table periodically.

Step 4.1: periodically make queries to the independent service management, the service will update current status of all instances.

Step 4.2: go through all the IP addresses of each server in the current list, check with the list returned from the independent service management.
If an IP address is not available in the returned list, continue to delete that IP address in the server list, delete the connection within the connection list.

Step 4.3: the rest of the IP address in the returned list are the newly allocated IP addresses, add these IP address into the current list, establish new connections to them and add to connections list.

### Example of Implementation:

The proposal have been implemented in the process of communicating over HTTP2 protocol between all micro-services of subscriber's sessions management module (Session Management Functions—SMF), the 5GCore system which was design and developed by Viettel Group.

### BENEFITS OF THE INVENTION

The invention helps establishing a pool of connections between client instances and server instances without going through service, this also increase the number of connections which reduces complexity and enhances the data transferring performance.

The proposal helps guaranteed the load balancing capability when any instance is changed (add or remove) or in time of failure.

The proposal can be applied to system that requires transferring data between micro-services over HTTP2 protocol.

1. A connection establishment method in data transmission between micro-services in cloud comprising:
step 1: preparing. Client side data which includes:
+a list of status and IP information of all backend instances of N servers;
+a list of connections, which includes the connections between a client and M instances of N servers;
+a marking list, which will be used to mark and load balance when selecting IP of server side instances;
step 2: building table of connections:
make queries to an independent service management to collect information about every instances of available servers including,
a list of N servers [S_1, . . . , S_N] that need to be connected to;
a list of IP addresses of M instances [IP_1, . . . , IP_M] corresponding to each server [IP_S_1_1, . . . , IP_S_1_M], initialize load-balancing indexes value for each instance of each server;
based on information within the those lists, create a pool of HTTP2 connection witch each IP address of an instance, this pool will include:
K connections from client to each IP address of each instances of server side [C_1, . . . , C_K];
Index value to mark the connection;
step 3: selecting an appropriate connection when sending a request from client side:
based on the request from client and the data stored, select an appropriate connection to send and receive messages over HTTP2 protocol, specifically:
step 3.1: based on a server identity that will be receiving message from client, select an IP address from the list with index IP_S_X_Y. S_X is the identity of the server, Y is the corresponding index value;
step 3.2: update the server index value by 1;
Index=(Index+1) % M;
step 3.3: based on the IP address obtained from step 3.1 (IP_S_X_Y), select an appropriate connection based on the index values of connections C_Z, Z is the index value;
step 3.4: update the connection index value by 1;
Index=(Index+1) % K;
step 3.5: check the connection if the connection is not functioning then proceed to reselect a new connection according to step 3.3;
step 3.6: return the used connection for other processes;
step 4: update the connection table periodically;
step 4.1: periodically make queries to the independent service management, the service will update current status of all instances;
step 4.2: go through all the IP addresses of each server in the current list, check with the list returned from the independent service management;
if an IP address is not available in the returned list, continue to delete that IP address in the server list, delete the connection within the connection list;
step 4.3: the rest of the IP address in the returned list are the newly allocated IP addresses, add these IP address into the current list, establish new connections to them and add to connections list.
